(19) United States
(12) Patent Application Publication
(10) Pub. No.: US 2012/0224357 A1
(43) Pub. Date: Sep. 6, 2012

(54) LOW-PROFILE SIDE MOUNTED LASER SIGHTING DEVICE

(76) Inventor: Larry E. Moore, Cottonwood, AZ (US)

(21) Appl. No.: 13/353,301

(22) Filed: Jan. 18, 2012

Related U.S. Application Data
(60) Provisional application No. 61/433,874, filed on Jan. 18, 2011.

(51) Int. Cl. F41G 1/35; B23P 11/00; F21L 4/00

(52) U.S. Cl. 362/110; 362/191; 29/592.1

(57) ABSTRACT

A lighting device is mountable on the side of an automatic pistol by using openings already formed in the pistol body to connect the pistol body to the frame rail of the pistol using frame insert pins. In a retrofit application, to connect the lighting device to the pistol, the frame insert pins are removed from the pistol, the lighting device is aligned with the side of the pistol such that one or more apertures of the lighting device align with an opening in which the frame insert pin(s) were removed, and either the same frame insert pins, or slightly longer ones, are inserted through the aligned apertures and openings. In this manner, the lighting device is mounted to a side of the body of the pistol, and the side portion of the body of the pistol is again connected to the frame rail.

### CROSS REFERENCE TO RELATED APPLICATIONS

This application claims priority to and incorporates by reference the disclosure of U.S. Provisional Patent Application No. 61/433,874 entitled LOW-PROFILE SIDE-MOUNTED LASER SIGHTING DEVICE, filed on Jan. 18, 2011. To the extent not inconsistent with this disclosure, this application incorporates U.S. Pat. No. 8,006,428 entitled “Gun-Mounted Sighting Device” and U.S. patent application Ser. No. 12/249,781 entitled “Slot-Mounted Sighting Device” by reference.

### FIELD OF THE INVENTION

The present invention relates to lighting devices for automatic pistols.

### BACKGROUND OF THE INVENTION

It is known to attach lighting devices, such as laser sighters, to guns in order to assist with properly sighting the gun. The addition of a lighting device, however, can require machining or altering components of the gun, or the lighting device may be a high-profile component that makes it difficult or impossible to place the gun into a holster or pocket, or that makes the gun off balanced.

### SUMMARY OF THE INVENTION

The present invention is a lighting device that mounts onto the side of an automatic pistol (or “gun” or “pistol,” as used herein) by utilizing openings already formed in the pistol to receive insert pins, which are fasteners that connect a portion of the pistol's body to a frame rail of the gun. To install a lighting device of the invention in a retrofit application, one or more of the insert pins is first removed, usually using a simple tool such as a wrench, hex driver, or screw driver. This exposes the opening(s) into which the insert pin(s) had been positioned. Then, the lighting device (or “device,” as used herein) is positioned onto the side of the pistol so that each of one or more apertures in the device align with a respective opening into which an insert pin had been positioned. Then the same insert pin, or a different and slightly longer insert pin, is inserted through each aligned aperture and hole in order to secure the device to the side of the gun, and again secure the portion of the gun's body to the frame rail.

For new equipment applications a device according to the invention could be mounted to the pistol, in which case the insert pins would not have to be removed. The device could simply be mounted with proper sized insert pins as the pistol is assembled.

Preferably, a lighting device according to the invention has a low profile and extends outward from the side of the gun by ⅜″ or less. The laser used with the lighting device preferably pulses at a frequency of 1 KHz and a 50% duty cycle in order to utilize less power during operation.

### BRIEF DESCRIPTION OF THE DRAWINGS

Figure A is an exploded view of an automatic pistol with which a lighting device according to the invention may be used.

FIG. 1 is an exploded view of a side-mounted lighting device according to an aspect of the invention.

FIG. 2A is a top view of a main housing of a lighting device according to an aspect of the invention.

FIG. 2B is a side view of the main housing of the lighting device shown in FIG. 2A.

FIG. 2B1 is a front view of the main housing of the lighting device shown in FIG. 2A.

FIG. 2C is another side view of the main housing of the lighting device of FIG. 1.

FIG. 2D is a front view of the main housing of the lighting device of FIG. 1.

FIG. 3 is a bottom, perspective view of a lighting device according to FIG. 1.

FIG. 4 is a top view of a lighting device according to FIG. 3.

FIG. 5 is a bottom view of a lighting device according to FIG. 3.

FIG. 6 is a side view of an assembled lighting device according to FIG. 1.

FIG. 7 is a side view of the assembled lighting device of FIG. 1, an automatic pistol to which the device is to be mounted, and fasteners (also called insert pins or frame insert pins) used to mount the laser sighting device to the pistol.

FIG. 8 is a side view of the assembled lighting device of FIG. 1 attached to the pistol shown in FIG. 7.

### DETAILED DESCRIPTION OF PREFERRED EMBODIMENTS

Turning now to the figures, wherein the purpose is to describe a preferred embodiment of the invention and not to limit same, Figure A shows an exploded view of an automatic pistol 50 on which a laser sighting device according to the invention may be used. Figure A was obtained from www.ruger.com/proudcts/_manuals/lcp.pdf.

Pistol 100 has a slide 1, a firing pin retainer 2, an extractor spring 3, and extractor plunger 4, an extractor 5, a firing pin spring 6, a firing pin 7, a guide rod 8, an inner recoil spring 9, an outer recoil spring 10, a barrel 11, a frame insert 12 having frame rails 12A, a trigger 13, a trigger pin 14, a trigger pivot 15, a hammer catch spring 16, a hammer pivot pin 17, a trigger bar 18, a hold open 19, a takedown pin detent 20, a hold-open detent 21, a hammer spring retainer pin 22, a hammer 23, a frame 24, a hammer spring 25, a trigger spring 26, a hammer catch 27, a magazine latch catch 28, two frame insert pin 29, a takedown pin 30, a hammer catch pin 31, a magazine latch spring 32, a hammer spring seat pin 33, a hammer spring seat 34 and a magazine 35.

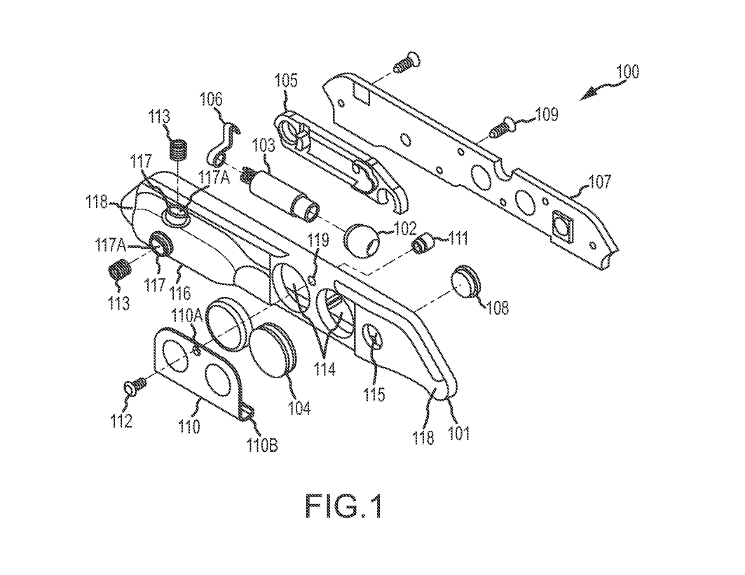

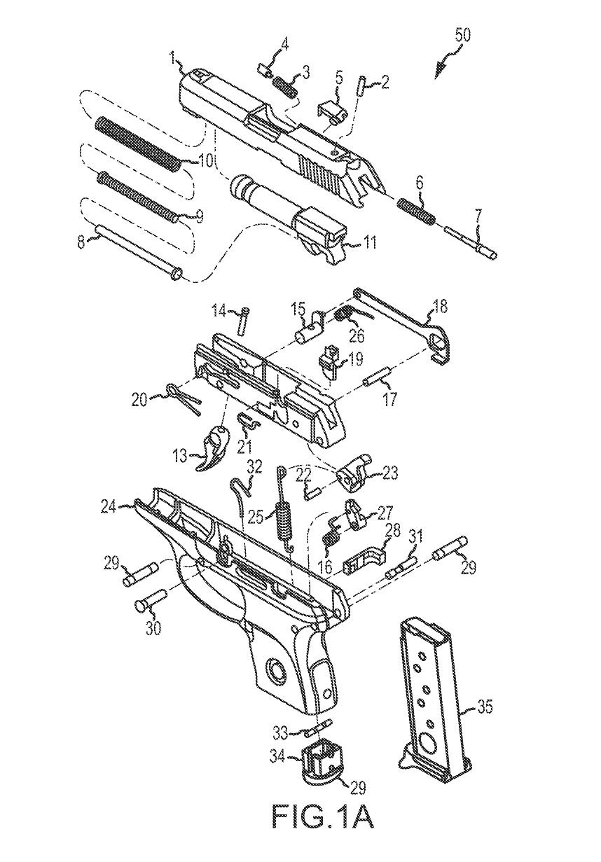

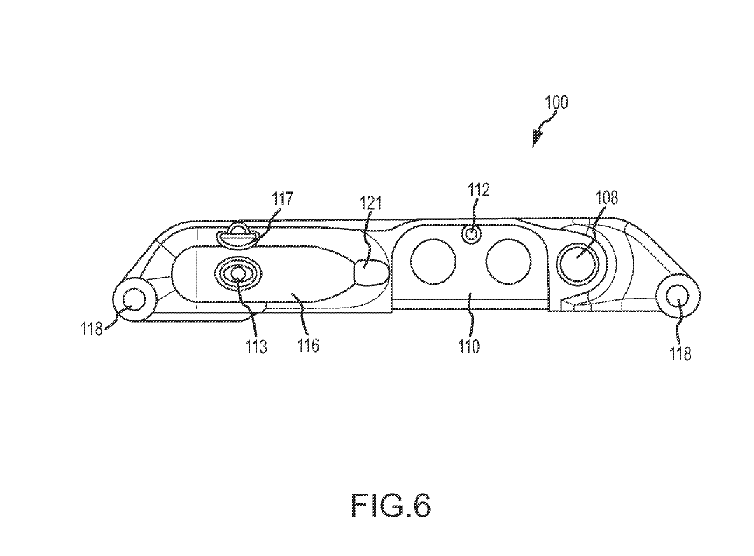

A lighting device 100 according to the invention is shown in FIGS. 1-8. Device 100 has a main housing 101 that is preferably made of plastic, but that could be made of metal or any suitable material. Housing 101 has two openings 114 that receive batteries 104 (which are preferably 3V lithium coin cell batteries, although any suitable power source could be utilized), an opening 115 that receives an off/on button (or switch) 108, a raised housing portion 116 that houses a light source 103, which is preferably a laser module for generating laser light, and most preferably, a visible red-light laser, although it can be a green laser, LED laser, infra-red laser, or a flashlight. Device 100 is preferably about 3″ long and if a laser module is used, it is preferably about ½″ long.

Lighting device 100 also includes a module contact 106, module cushion ball (or ball socket) 102 (which receives the end of module 103 through which light is emitted), and laser module mount 105.

Reinforced sections 117 include apertures 117A that receive set screws 113. When device 100 is assembled, set screws 113 can be tightened or loosened to move laser light source 103 in the sideways and/or up-and-down directions in order to align it with the barrel of a gun to which device 100 is attached. Apertures 118 are configured to receive insert pins (also called frame insert pins) 29 in order to connect device 100 to a gun that is an automatic pistol, such as pistol 50, in the manner described herein. An insert pin may be threaded or have any attachment structure suitable of connecting device 100 to a gun, such as automatic pistol 50.

A backing 107 is also a circuit board that includes the circuitry that connects power from batteries 104 to laser module 103 and such circuitry is known to those skilled in the art.

A battery retention plate 110 is held in place by a screw (or other fastener) 112 that passes through opening 110, through opening 119 and is retained by thread insert 111. Plate 110 has a bottom ledge 110B that receives the bottom edge of main housing 101.

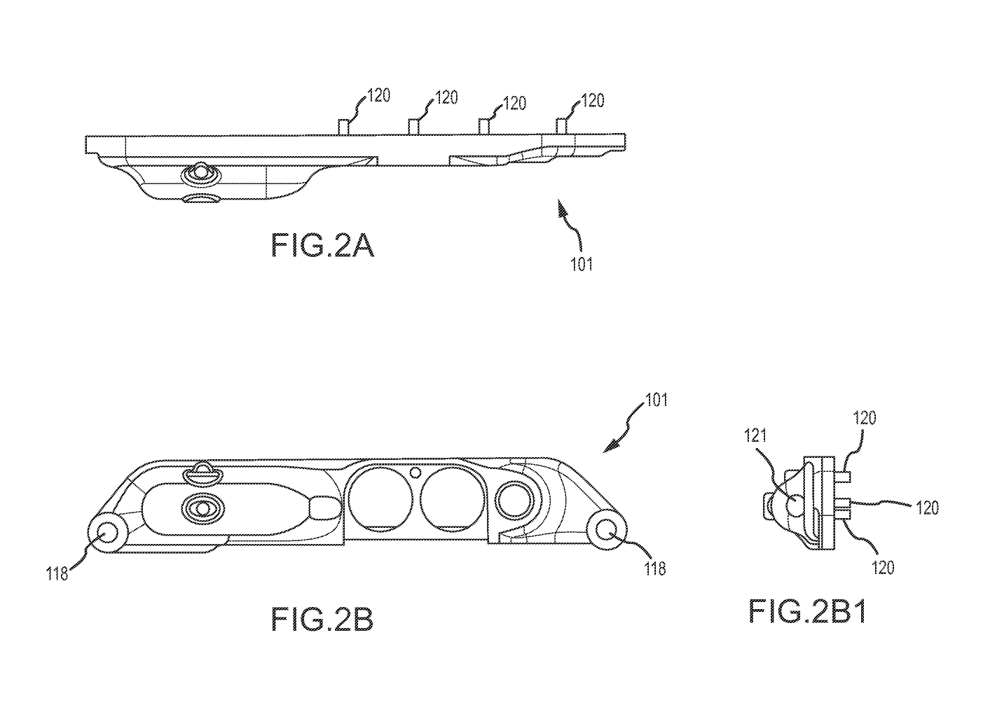

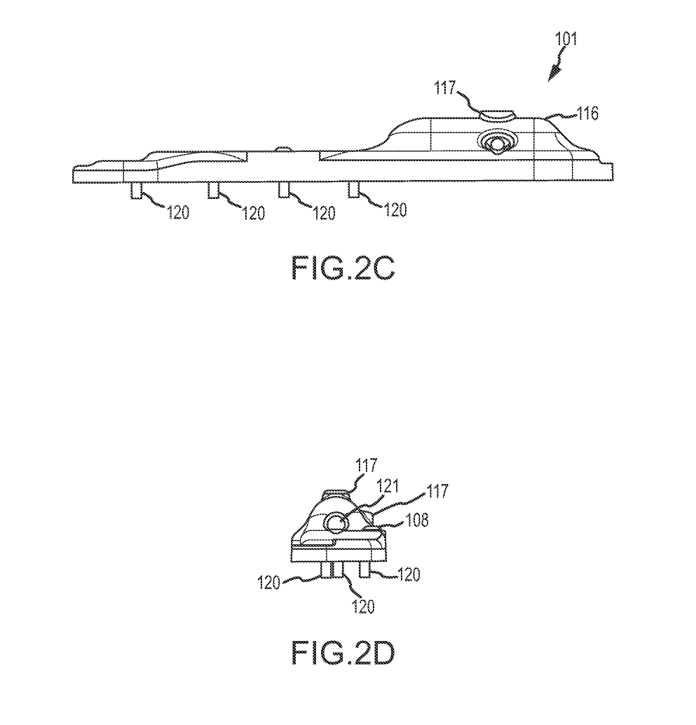

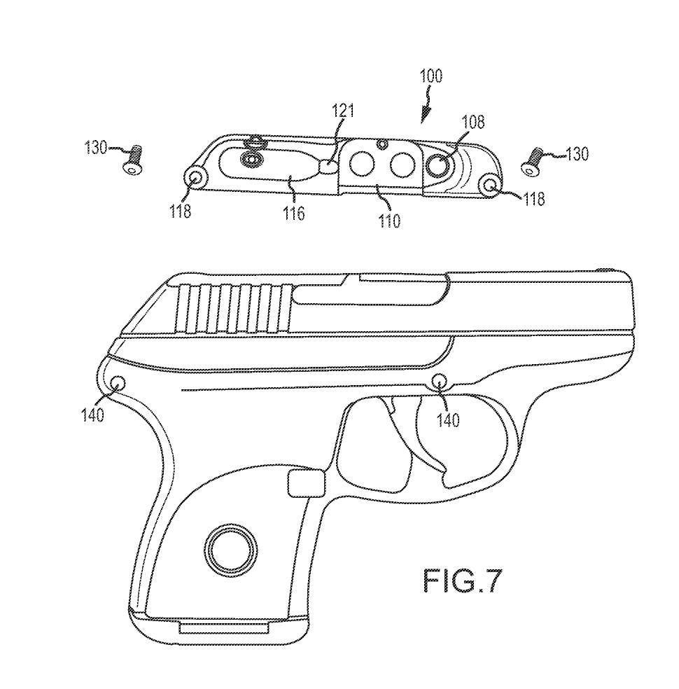

FIG. 2A shows a top view of main housing 101. Locator pins 120 are used to locate circuit board 107 onto main housing 101. FIG. 2B is a front view of the main housing 101. FIG. 7 is a front view of main housing 101, which shows the opening 121 through which laser light is emitted when module 103 is positioned in the assembled device 100. FIG. 2C is another side view of the main housing 101 and FIG. 2D is another front view of main housing 101, each without circuitry 107 attached. Screws 109 hold the circuitry 107 to main housing 101 and retain device 100 in its assembled position.

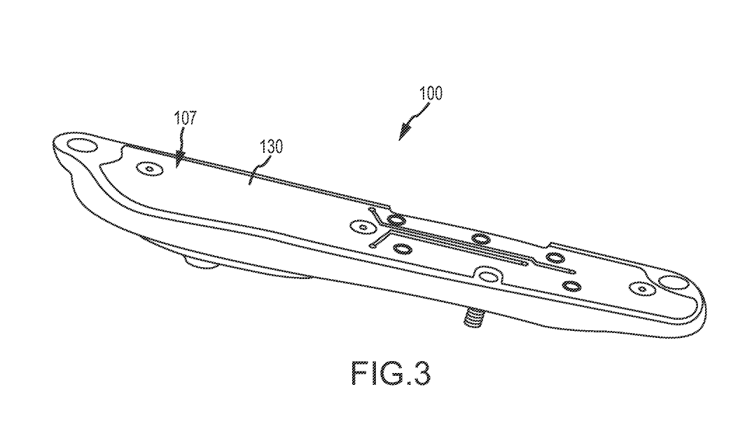

FIG. 3 is a bottom, perspective view of the device 100 fully assembled, with circuitry 107 attached to main housing 101 and showing a bottom surface 130. FIG. 11 is a top view of the fully assembled device 100. FIG. 12 is a bottom view of fully assembled device 100 showing circuitry 107.

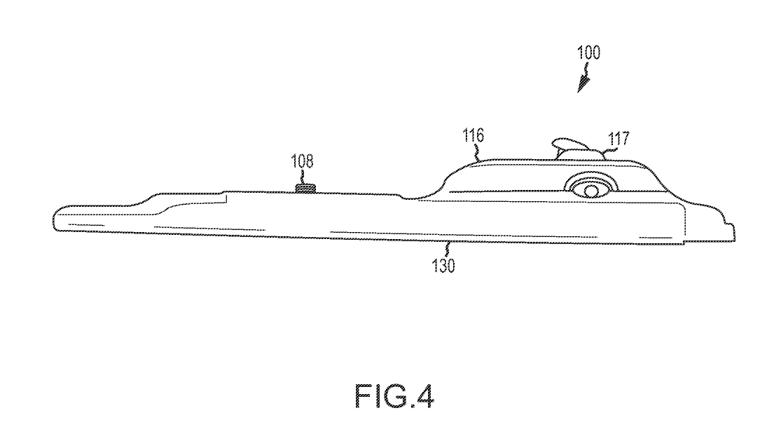

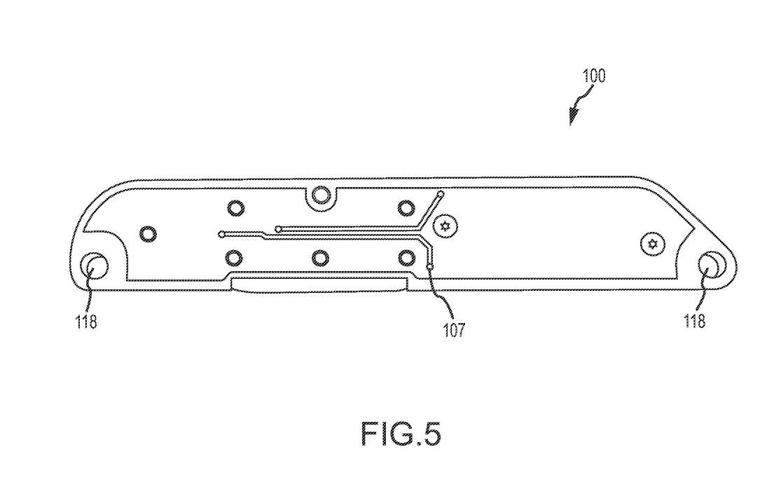

FIG. 4 is a side view of the fully assembled device 100 showing, among other features, the raised portion 116 of the housing, an aperture 117 that receives a set screw 103, and on/off switch 108.

FIG. 5 shows backing/circuit board 107. Circuit board 107 connects the light source 103 to batteries 104, and when the light source 103 is a laser, preferably causes the laser to pulse at a frequency of 1 KHz and operate at a 50% duty cycle when turned on and operating in a continuous mode. Circuit board 107 could also cause the laser to operate in a blink mode. Circuit board 107 may also include a time-out circuit, wherein the time-out circuit turns the laser off after the laser has been on for a predetermined time, for example, when the laser has been on for five minutes.

Circuit board 107 could also be designed to cause the laser to (1) operate at about 12 mA at 3V, and/or at a 50% duty cycle.

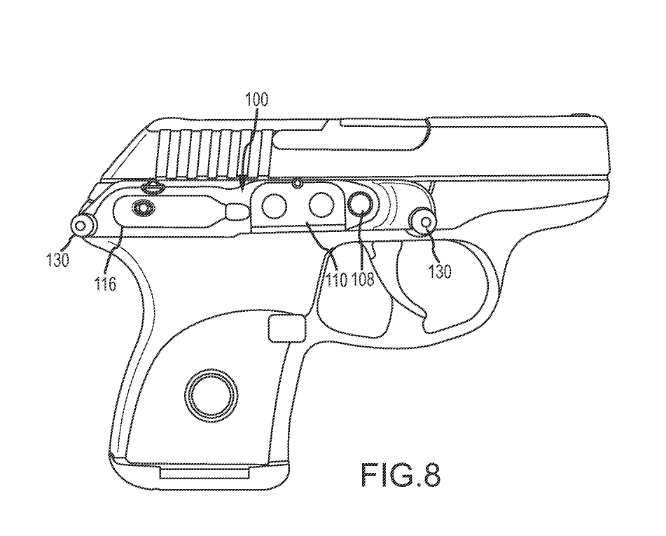

FIG. 7 shows a side view of device 100 prior to being mounted on an automatic pistol of the type in FIG. 1 in a retrofit application. Here, the insert pins 29 have been removed from openings 140 of the pistol. In this case, lighting device 100 will be positioned against the side of the pistol with exposed openings 140 and each of apertures 118 will be aligned, respectively, with an opening 140. Here, new insert pins 130 (which are slightly longer than removed insert pins 29 in order to compensate for the thickness of device 100) will be placed through apertures 118 and openings 140 and threaded into a frame rail 112A (not shown here), which is inside of the pistol. That will secure device 100 and the body portion of the pistol to the frame rail, as is best seen in FIG. 8. The structures and method of assembly of the pistol body portion to the frame rail using insert pins is known to those in the art.

As shown in FIG. 8, when assembled on a pistol, in this embodiment the lighting device 100 is positioned behind and above the trigger guard of the gun to which it is mounted. It is also positioned above the grip, so device 100 does not interfere with a user's grip of the gun or use of the trigger. Furthermore, the light is a laser module positioned in raised portion 116, which is behind and positioned higher on the gun than the trigger guard. Raised portion 116, which is the highest portion of device 100, extends outward no more than ⅜″ from the side of the pistol to which it is mounted. Consequently, a pistol including device 100 is relatively easy to holster or place in a pocket, and device 100 does not interfere with aiming the pistol.

Having thus described some embodiments of the invention, other variations and embodiments that do not depart from the spirit of the invention will become apparent to those skilled in the art. The scope of the present invention is thus not limited to any particular embodiment, but is instead set forth in the appended claims and the legal equivalents thereof. Unless expressly stated in the written description or claims, the steps of any method recited in the claims may be performed in any order capable of yielding the desired result.

What is claimed is:

1. A lighting device for being mounted on the side of an automatic pistol that has a body portion and a frame rail, wherein the lighting device has a light source, a power source, circuitry connecting the power source to the laser, and one or more apertures, and is configured to be mounted to the automatic pistol by aligning at least one of the one or more apertures with an existing opening in the side of the pistol, and positioning an insert pin through each aligned aperture and hole and securing it into the frame rail of the pistol.

2. The lighting device of claim 1 that includes two apertures, wherein each of the apertures aligns with a separate, existing opening in the body portion, and an insert is positioned through each of the aligned apertures and openings in order to secure the lighting device to the body portion and secure the body portion to the frame rail.

3. The lighting device of claim 1 wherein the light source is a laser.

4. The lighting device of claim 3 wherein the laser is a red laser.

5. The lighting device of claim 4 wherein the laser is a green laser.

6. The lighting device of claim 1 wherein the light source is a flashlight.

7. The lighting device of claim 3 wherein the laser pulses at a frequency of 1 KHz and a 50% duty cycle when the laser is turned on.

8. The lighting device of claim 1 wherein the light source is controlled by a switch that turns the light source off or on.

9. The lighting device of claim 3 that includes a time-out circuit, wherein the time-out circuit turns the laser off after the laser has been on for a predetermined time.

10. The lighting device of claim 9 wherein the predetermined time is 5 minutes.

11. The lighting device of claim 3 wherein the laser is designed to operate at about 12 mA at 3V, and is operated at a 50% duty cycle.

12. The lighting device of claim 3 wherein the laser is configured to operate on a continuous mode or on a blink mode.

13. The lighting device of claim 12 wherein, when in the continuous mode, the laser pulses at 1 KHz at a 50% duty cycle.

14. The lighting device of claim 1 that is about 3″ or less in length.

15. The lighting device of claim 1 that is about ½″ in height at its highest point.

16. The lighting device of claim 3 that includes a laser module that is about ½″ in length.

17. An assembly comprising (a) an automatic pistol having a body portion, a frame rail to which the body portion is attached, a trigger guard, and (b) a lighting device as described in claim 1 attached to the body portion of the automatic pistol by at least one insert pin passing through the lighting device, the body portion and being received in the frame rail.

18. The automatic pistol of claim 17 wherein the lighting device extends ⅜″ or less from the body portion.

19. The automatic pistol of claim 17 wherein the light source is positioned behind the trigger guard.

20. The automatic pistol of claim 14 wherein the highest point of the lighting device is behind the trigger guard.

21. The automatic pistol of claim 17 wherein the body portion is comprised of plastic.

22. The automatic pistol of claim 17 wherein the frame rail is metal.

23. The automatic pistol of claim 17 wherein the frame rail is steel.

24. A method of attaching a light source to an automatic pistol having a body portion and a frame rail, the method comprising the steps of:
removing insert pins that hold the body portion to the frame rail;
positing the light source on the body portion so that apertures in the light source align with openings in the body portion from which the insert pins were removed;
retaining the body portion and light source to the automatic pistol by inserting the insert pins or new insert pins into the aligned apertures and openings, where they are received and retained in the frame rail.

25. The method of claim 24 wherein the insert pins used to retain the body and light source are longer than the insert pins removed from the automatic pistol.
